(19) United States
(12) Patent Application Publication
(10) Pub. No.: US 2010/0019575 A1
(43) Pub. Date: Jan. 28, 2010

(54) SYSTEM AND METHOD FOR CREATING AND CONTROLLING A VIRTUAL POWER DISTRIBUTION UNIT

(76) Inventor: Christopher Eugene Verges, San Carlos, CA (US)

Correspondence Address: MICHAEL W. CALDWELL, 4226 RIVERMARK PARKWAY, SANTA CLARA, CA, 95054-4150, US

(21) Appl. No.: 12/177,881

(22) Filed: Jul. 22, 2008

(51) Int. Cl. H02J 3/00

(52) U.S. Cl. 307/38

(57) ABSTRACT

A system for managing a virtual power distribution unit includes database management resources and means for remotely connecting to one or more physically separate power distribution units by a controller. The controller is sometimes implemented as custom logic, or a personal computer which executes computer program instructions and communicates via a local area network or an internet connection. A database is manipulated to allow control and presentation to a user of what appears to be a standard power distribution unit but is instead a virtual version comprised of one or more physical power outlets from one or more power distribution units, allowing control and observation of the virtual power distribution in the same manner as an individual physical power distribution unit. Multiple versions of virtual power distribution units may be formed from a given set or sets of physical power distribution units.

### BACKGROUND

Power distribution units (“PDUs”) are typically used in systems wherein a plurality of electrical power outlets are needed. The outlets may provide a variety of voltages and current capabilities, or may all be the same. Examples of use of a PDU include computer rooms, network rooms or cabinets, hospital operating rooms, communications systems, military installations, manufacturing facilities and many others. Often times a power distribution unit receives a high power electrical feed from a central supply, the PDU then providing a plurality of power outlets (sometimes denominated “power ports”) in parallel, allowing individual loads to be connected to certain outlets which provide electrical power appropriate for the individual load. Typically a PDU is provided with a circuit breaker protecting the entire unit, and the PDU may be turned ON or OFF, either physically or remotely. An individual outlet may also be individually provided with certain other features, such as a ground fault interrupt (“GFI”) unit, special noise filtering, noise suppression, surge protection, or other features desired for a given load.

In the prior art a plurality of PDUs are deployed geographically. That is, each PDU is physically placed near where it is used. However the various loads connected to a given PDU may have very diverse uses. For example, a facility may have a PDU providing power for a computer cabinet, cooling equipment, safety equipment, lighting, security alarms, and other diverse loads. In some systems provision is made in the PDU for remote control and/or monitoring. The remote provision can include the ability to control or monitor a PDU via a local area network. If the local area network includes a gateway to the internet, the PDU may also include the capability for remote control and monitoring that may be accomplished from literally anywhere in the world.

Control and monitoring systems provide the means for management of a plurality of PDUs, including control and monitoring from a central location. However each PDU is treated in the same way it is deployed: as a whole unit. Programming of functions, for example lighting schedules and entry/egress gate power schedules, requires the user to keep track of the assignment of each power outlet of each PDU, where the PDU is, what load is assigned and other information, making it difficult to comprehend and control all of the loads correctly and efficiently.

What is needed is a method for managing the various loads, or category of loads, powered by individual PDU power outlets without regard to the specific PDU within which a power outlet is physically incorporated. It is also desirable to be able to determine aggregate use and characteristics of a collection of power outlets that are not physically instantiated within a common PDU.

### SUMMARY

The present invention provides a method for creating a virtual PDU, or “VPDU”, wherein a VPDU is comprised of a plurality of physical power outlets from a plurality of individual PDUs, the outlets logically combined and managed as though the VPDU were a single physical PDU. A VPDU is comprehended by a user or controller in the same manner as it is with a conventional or so-called “real” PDU. However the various outlets of a VPDU may be located anywhere in the world to which a central controller has signal access, such as via a LAN or an internet connection. The VPDU is “created” by using systems and software according to the present invention, wherein a user selects disparate individual PDU outlets to be associated with a certain collection. The collection may then be managed by the user exactly as the user would normally manage a single physical PDU. That is, as with a physical PDU, a VPDU may be managed as a single unit, or a subset of the outlets associated with the VPDU may be managed individually. Additionally, characteristic and use data may be collected for the VPDU or a subset of the VPDU, much as it is available in a typical PDU. For example, all interior lights of a campus may be logically mapped by software to a single VPDU, thereafter the entire VPDU scheduled for times at which the interior lights are to be turned ON or OFF. In some embodiments PDUs provide means for measuring and reporting power characteristics such as peak current, over or under voltage, tripped circuit breakers, watt-hours used and other data which a VPDU then reports as though the individual reports and the aggregate of them were related to a real PDU comprised of the outlets that were previously selected to be associated with the VPDU.

In an example illustrative of the utility of the present invention, consider a VPDU defined as a collection of electrical outlets powering HVAC air conditioning equipment deployed across an industrial campus, each air conditioning unit powered by a different physical PDU. The facility may have negotiated a lower electrical power rate from its power provider by agreeing to allow the power provider to turn OFF power to the HVAC air conditioning equipment for a certain period of time on days in which the power provider has inadequate capacity, such as during a heat wave in the area. The power provider is provided with the ability to turn the power provided to the air conditioning equipment ON or OFF remotely via an internet connection. Similarly the lights of a facility may be virtually incorporated into a “lights VPDU” and a schedule provided by the user to turn OFF certain lights while leaving others ON during a power outage or an emergency, such as a fire. In one embodiment of the present invention a critical electrical appliance is provided power from two or more separate physical PDUs for power redundancy. A VPDU defined as the two or more outlets providing power to the common appliance may be turned ON or OFF, thereby turning all outlets ON or OFF simultaneously. One skilled in the art will know of many other scenarios of utility for the present invention.

### BRIEF DESCRIPTION OF THE DRAWINGS

FIG. 1 is an exemplary power distribution unit system. PRIOR ART.

FIG. 2 is an example of a connection model for a plurality of power distribution units. PRIOR ART.

FIG. 3 is an example of a connection model for a plurality of power distribution units according to the present invention.

FIG. 4 is an example of a plurality of power distribution units connected to multiple power loads.

FIG. 5 is an example of a database table according to the present invention.

FIG. 6 is an example of how a display console might present connections in a power distribution system.

FIG. 7 is an example of control logic for managing commands to a virtual power distribution unit.

### DETAILED DESCRIPTION OF THE INVENTION

Definition of some terms:

| | |
|---|---|
| PDU | Industry standard term for a power distribution unit. A PDU has |
| | electrical outlets that may be turned ON or OFF. |
| VPDU | A virtual PDU. Sometimes referred to as a “logical PDU.” |
| LAN | Local Area Network. |
| Outlet | A mechanical port to which a load may be connected. The load may be |
| | an electrical appliance or a branch to another outlet or a plurality of |
| | outlets. A load may be removable (unplugged) or hard-wired. |
| | Sometimes called a “power terminal”, “electrical outlet”, “power outlet” |
| | and other similar terms. |
| EMC | Enterprise Management Console. A GUI or command-line interace for |
| | controlling the outlets of one or more PDUs. |
| Gateway | An interface device, connecting one or more network nodes to the |
| | internet and/or to each other. Sometimes referred to as a “router.” |
| GUI | Graphical User Interface. A visual presentation enabling a human user |
| | to visualize and control a physical asset, such as a computer or a |
| | controller controlling an outlet in a PDU. |
| NIC | Network Interface Card. An electronic circuit providing LAN connectivity |
| | to an electronic appliance such as a computer or a PDU. |
| Internet cloud | Reference to connectivity between two or more electronic apparatus |
| | using the world wide web, for example via a TCP/IP connection. |
| wifi | The trade name for a popular wireless data communications technology |
| | used in home networks, mobile phones, video games and more. |
| PC | Personal Computer. |
| OS | Industry standard term for the operating system of a computing device, |
| | such as a PC. |
| HVAC | Industry standard term for a heating, ventilation, and/or air conditioning |
| | system. |

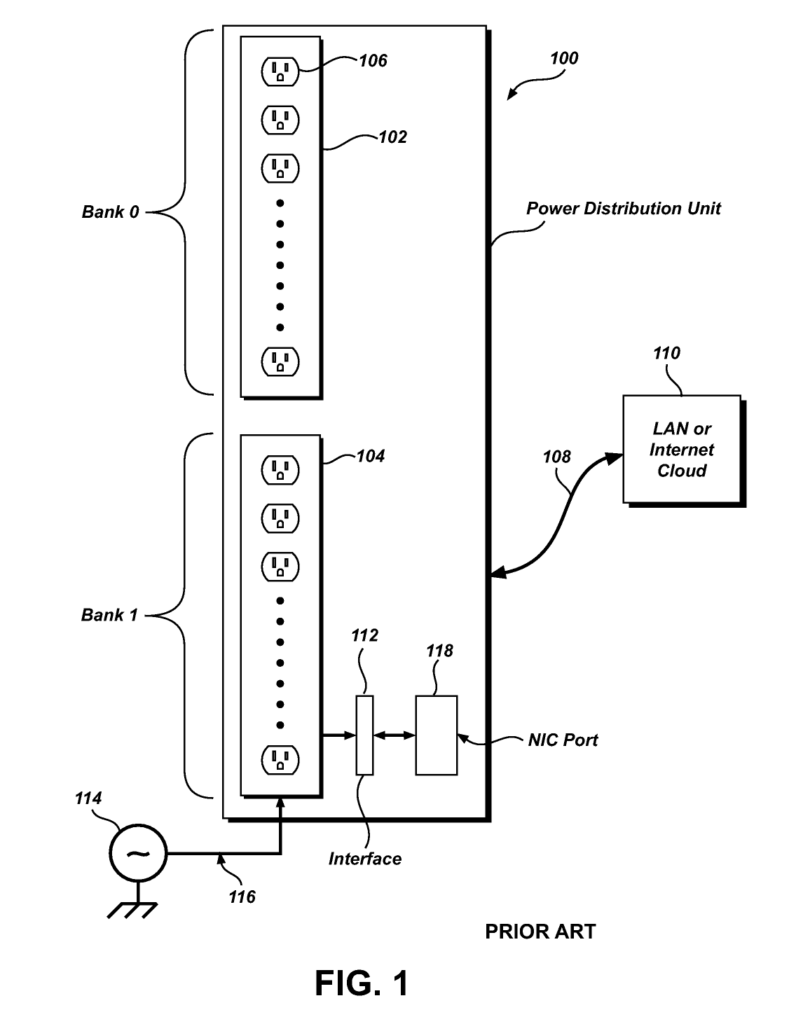

FIG. 1 (PRIOR ART) is a typical PDU 100 comprising a Bank0 102 of power outlets 106 (typical of a plurality of outlets in one or more banks) and sometimes a similar Bank1 104; a common source of power 114, for example 60 Hz 110 VAC; a supply bus or cable 116 from the source of power 114, internally distributed to the various outlets 106 (not shown); an interface circuit 112 wherein the interface circuit 112 includes means for connecting and disconnecting power from the common source 114 to a given individual power outlet 106; a NIC circuit 118 wherein the NIC circuit 118 provides control signals or commands to the interface circuit 112 and further wherein the NIC circuit 118 is connected 108 to a LAN or to the “internet cloud” 110 by electronic means 108. Electronic means 108 may be any of a variety of connectivity methods such as an Ethernet connection, wifi signals, phone or cable or DSL modem and may or may not include a router or gateway. The PDU 100, then, may be controlled remotely by any means that can connect to the NIC 118 through the electronic means 108, thereby to provide commands to the interface 112. The interface 112 is responsive to commands the interface 112 receives to turn a selected power outlet 106 ON or OFF. In many embodiments the interface circuit 112 includes means to sense or measure and to report such information as the instant or peak current provided to a given load or an aggregate of loads; energy used during a certain time window; maximum power within a certain time window, and other information as may be enabled by the design of a given physical power distribution unit. An example of a PDU 100 is a Model Dualcom 1630ViCB, available from Cyber Switching, Inc., 1281 Wayne Ave, San Jose, Calif. 95131.

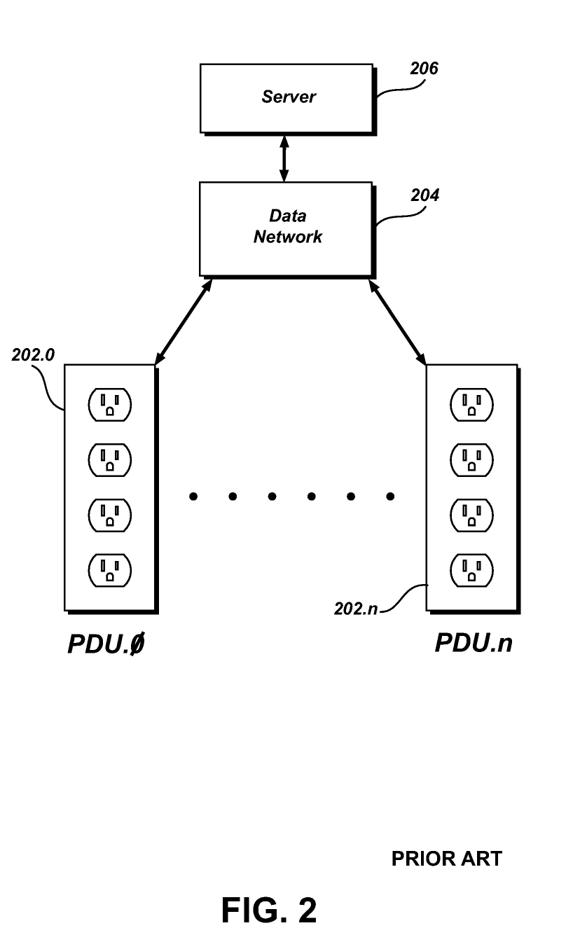

FIG. 2 (PRIOR ART) illustrates an installation wherein a plurality of PDUs 100 (shown as PDU.0 202.0 through PDU.n 202.n; referred to severally or collectively as “PDU 202”) are electrically connected via a common data network 204, for example a LAN. Note that other types of power distribution devices may be substituted for a given PDU 202. For example, in some embodiments a power management circuit comprising one or more circuit breakers and/or relays provides power to downstream appliances (any of which may be a PDU 100) is connected to the data network 204. Each PDU 202 is assigned an IP address. A server 206 provides control signals to each PDU 202 via the data network 204, as shown in more detail in FIG. 1.

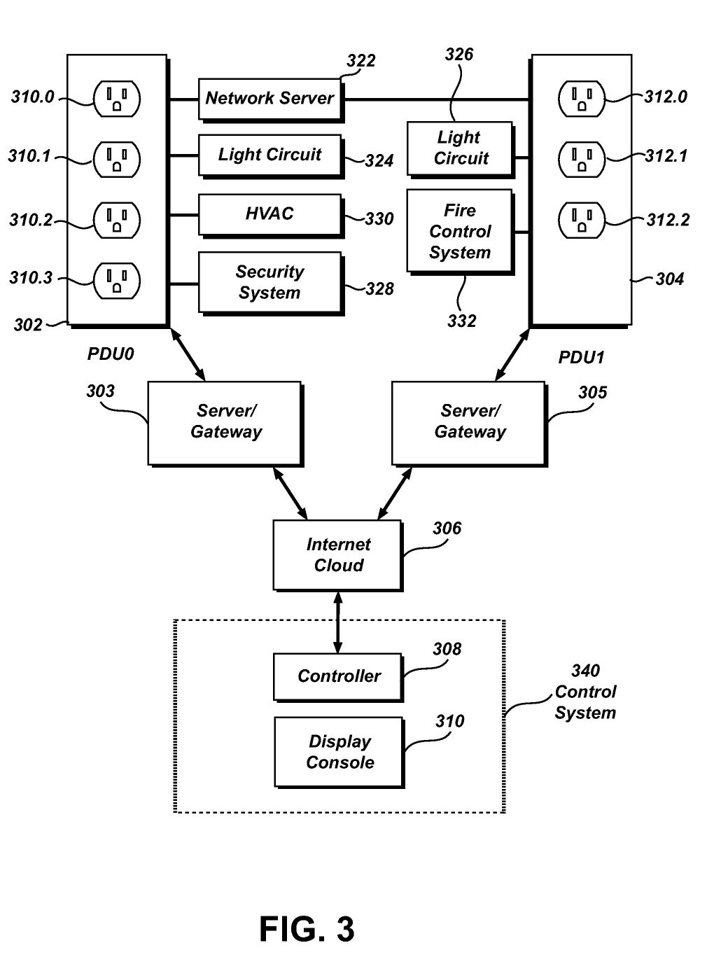

FIG. 3 illustrates one embodiment of the present invention. For clarity, PDUs shown in FIG. 3 will be given a different reference number, but it should be understood that each such PDU is consistent with the PDU 100 of FIG. 1 and PDU 202 of FIG. 2. Some internal details, such as NIC cards, are not shown so as not to obscure the connections as used by the present invention. Consider the minimal example of a PDU0 302 and a PDU1 304, wherein the PDUs 302, 304 are not collocated. PDU0 302 is connected to a server/gateway 303 and PDU1 304 is connected to a server/gateway 305. The connection between each PDU 302, 304 and its respective server 303, 305 may be via wired LAN, fiber optic cable, Bluetooth radio signal, wifi radio signal, or other means of network connectivity. The servers 303, 305 are shown connected via the internet cloud 306 to a control system 340. In one embodiment the control system 340 comprises a controller 308 and a display console 310. Several architectures of the control system 340 are possible and within the scope of the present invention. Examples include the controller 308 being in one location while the display console 310 is elsewhere. In another example the display console 310 is a PC connected to the controller 308 via an internet connection (not shown). In some embodiments the controller 308 is connected to a LAN common to the servers 303, 305 and thus not connected to the servers 303, 305 via the internet. In some embodiments the controller 308 is incorporated in one of the servers; in other embodiments the controller 308 is remotely located and only connected to the servers 303, 305 via the internet cloud 306. In one embodiment the control system 340 comprises a PC.

In the example of FIG. 3, a power distribution unit PDU0 302 has four outlets 310.0 through 310.3 and another power distribution unit PDU1 304 has three outlets 312.0 through 312.2. The number of PDUs and the number of outlets per PDU is arbitrary; they may each be of any number. The controller 308 includes a processor and other resources commonly required for operating under software control, such as RAM, mass storage, and input/output terminals, and may be connected to the display console 310 and other human interface devices such as a computer mouse or touch screen. The control system 340 may be similar to a personal computer (“PC”) with an operating system such as Windows, Linux, or MAC OS or may be a custom designed controller that is for the explicit purpose of embodying the method of the present invention either by executing coded program instructions or a logical design.

In some embodiments control of the plurality of PDUs is mixed. That is, a given PDU may be locally controlled, either by a LAN connection or pushing buttons, and the same PDU controlled as a member of a VPDU, whether the entire PDU or a subset of the PDU power outlets is incorporated into the VPDU.

For ease of description and clarity of understanding, the method of the present invention will be described as embodied in software or firmware executed by the controller 308. Continuing to look to FIG. 3, for the purpose of illustration, assume that the power outlets of the PDUs 302, 304 are connected to example loads as shown in Table 1:

TABLE 1
Load Connections Of PDU Outlets

| Outlet | |
|---|---|
| Reference | Outlet Load |
| 310.0 | Network server 322 |
| 310.1 | Light circuit 324 |
| 310.2 | HVAC system 330 |
| 310.3 | Security system 328 |
| 312.0 | Network server 322 |
| 312.1 | Light circuit 326 |
| 312.2 | Fire control system 332 |

From the two PDUs 302, 304 a variety of VPDUs may be defined and used. For example, outlets 310.0 and 312.0 supply redundant power to a network server. By combining the two outlets as a VPDU a control system 340 may turn power to the network server 322 ON or OFF with a single command. If one of the outlets 310.0, 312.0 fails or a circuit breaker in one of the PDUs 302, 304 opens, the other outlet (310.0 or 312.0) provides power to the network server 322 and in one embodiment the failing or the non-failing outlet reports the failure to the controller 308. Another VPDU may be defined combining the outlets providing power to a light circuit 326 and a light circuit 324 (powered by outlets 312.1 and 310.1 respectively), enabling a report of energy used for lighting. These are simply two arbitrary examples of how power outlets in physically separate PDUs may be logically associated for the purposes of control and monitoring. Of course a plurality of outlets on a single, common PDU may also be associated to form a VPDU.

In some embodiments of the present invention “virtual circuit breakers” are created, wherein current limits are specified for a certain outlet or outlet set, then the outlet(s) disabled whenever the instant current value reported by the PDU is in excess of the predetermined maximum current value for a predetermined period of time. Similarly, high and/or low current limits may be predetermined and reports provided to the controller 308 when such limits are exceeded. For example, a low current limit for a specified outlet may be used to determine if the load connected to the outlet has failed or if the load has been unplugged from the PDU power outlet. Note that a collection of PDUs may be accessed by multiple controllers 308. A given outlet may also be defined as part of a VPDU on more than one VPDU/control system 340. Depending upon the design of a PDU, monitoring of current or other conditions and taking action upon an out-of-specification condition may be performed by the PDU itself with reporting of the action to the controller 308, or the PDU may only report the condition and the control console 308 takes action, for example by commanding that an outlet be turned OFF.

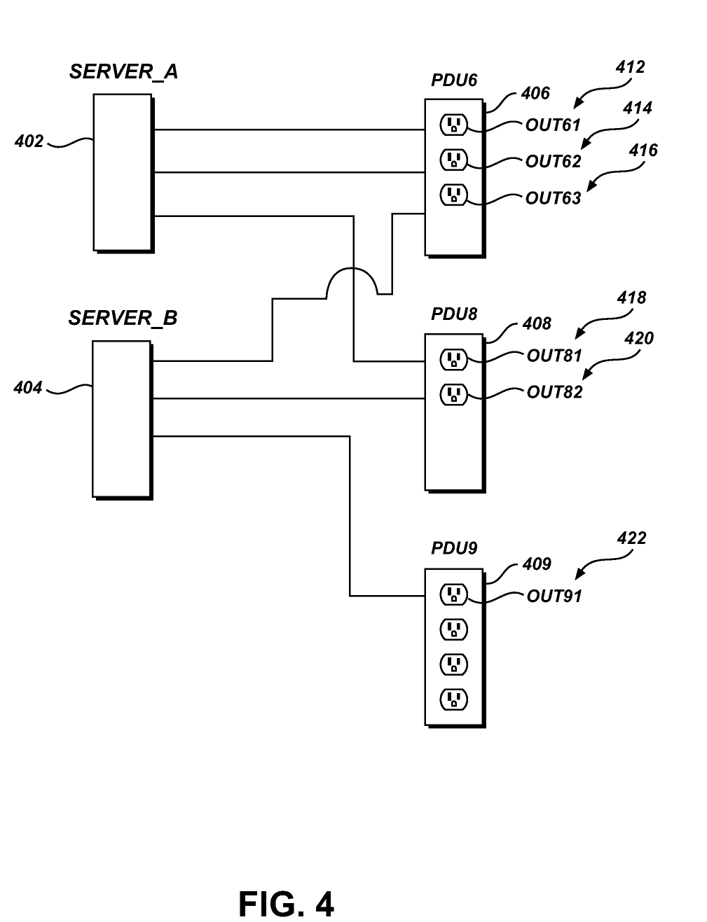

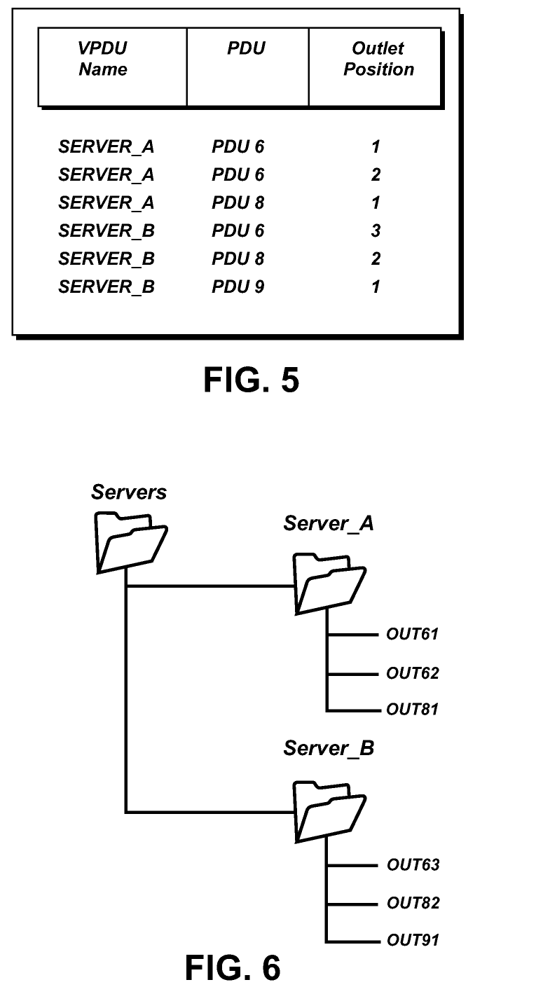

Management of a given power outlet may be ON and OFF control only, the monitoring of certain characteristics or states only, or both. Management of a collection of physical assets combined to form a VPDU is largely a database management procedure. The following description illustrates one embodiment of such a database management structure with procedures, though one skilled in the art will know of many alternative database management techniques equally able to embody the method of the present invention, which are within the scope of the present invention. The database is described as fields with records, however a control program associated with, for example, a computer may display certain database tables to a viewer as folders with subfolders, files, and the like. Consider FIG. 4 and FIG. 5. FIG. 4 shows two network servers, Server_A 402 and Server_B 404 and three PDUs PDU6 406, PDU8 408 and PDU9 409, wherein Server_A 402 and Server_B 404 are loads to the PDUs 406, 408, 409. Server_A 402 is provided power to its various subsystems (server subsystems and their various interconnections not shown) by PDU6 406 and PDU8 408. In the example shown, Server_A 402 is connected to power outlets OUT61 412 and OUT62 414 of PDU6 406 and OUT81 418 of PDU8 408. Server_B 404 is provided power to its various subsystems (not shown) by PDU6 406, PDU8 408, and PDU9 409. Server_B 404 is connected to outlets OUT63 416, OUT82 420, and OUT91 422. Of course each PDU may have other outlets serving other purposes (not shown).

FIG. 5 is an example of a database table corresponding to the connections shown in FIG. 4. The fields of the database table of FIG. 5 are defined in Table 2 below.

TABLE 2
Database Table Field Definitions

| Field | Field Description |
|---|---|
| VPDU | Arbitrary text that the user may use to describe the VPDU. |
| Name | |
| PDU | States which PDU available to the controller is providing power |
| | to an outlet corresponding to an instant database record. |
| Outlet | Position on the PDU of an outlet which is being controlled, |
| | corresponding to the instant database record. In the example |
| | the outlets are number sequentially. |

A display console 310 may display the data of the table in FIG. 5 in a manner suggesting folders and files, such as the example in FIG. 6. The utility of such an organization may be easily seen. For example, servers Server_A 402 and Server_B 404 may be installed in the electronic cabinet room of an office building wherein individual offices are rented by different renters and further wherein Server_A is owned by or leased to one office renter and Server_B is owned by or leased to another office renter. Though they share some PDUs, each renter may be billed for energy consumed by the server assigned to each renter by accumulating the energy used in association with their respective VPDU. Likewise it is now convenient to turn one server off for the weekend whilst the other remains powered. Each renter may be given network access to his own assigned VPDU, as though each renter actually had a different physical PDU associated with his server. Alternative techniques for managing the database and for presenting data to a user are within the scope of the present invention.

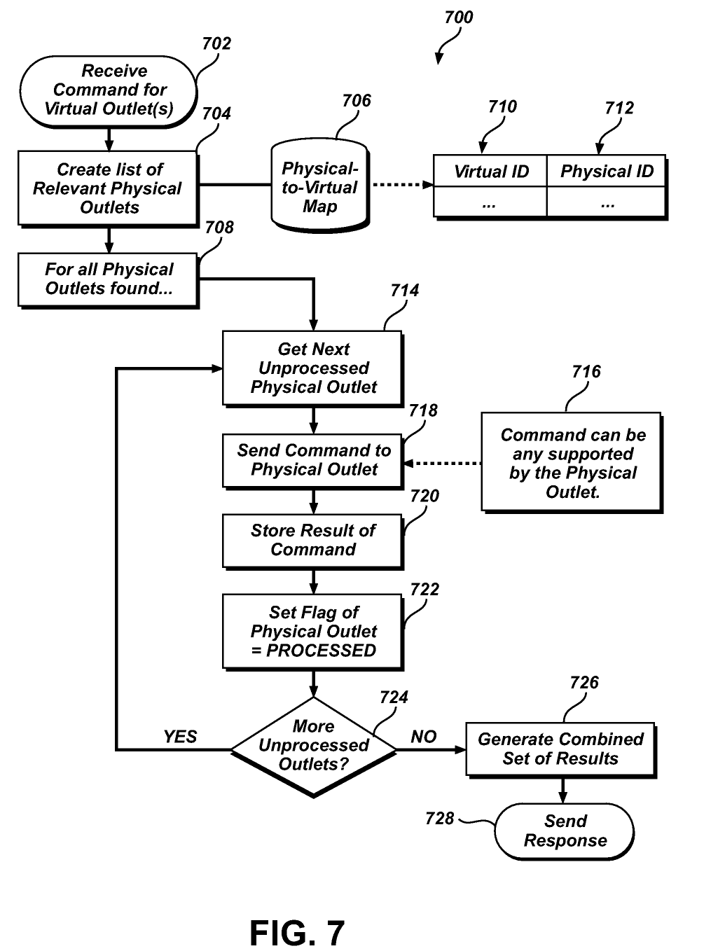

As stated hereinbefore, control of a VPDU may be implemented as a computer program, embedded firmware, custom logic, or other means for managing data, such as state variables. For clarity, FIG. 7 is provided as a flow chart of a software control program, and is an example of one embodiment of how a controller of any type would control one or more VPDUs. The logic flow in its entirety is referred to as “control flow 700”. At step 702 a command for one or more virtual outlets (that is, a physical outlet instantiated within a physical PDU, wherein the physical power outlet forms part of a virtual PDU) is received. The command may have been initiated by another controller, by a person typing at a computer console, by a power utility; these and other sources have been previously listed. Note that the command may have been “received” from the control program itself, such as a result of a certain predetermined condition, time of day, temperature, and the like. At step 704 a list of relevant (that is, addressed) physical outlets corresponding to the received command 702 is created. In one example, the command received is to add an outlet to the list of power outlets in a VPDU. Other commands, responded to similarly, may include commands to delete an outlet from the VPDU, turn an outlet ON or OFF; that is, any command supported by the physical outlet in the physical PDU and with the means to communications to them. Another class of commands would be a request for data from a PDU, as discussed hereinbefore.

In the example of FIG. 7, the next step is to update the physical-to-virtual PDU/outlet list, for example by writing into semiconductor memory (or mass storage device) the virtual ID 710 and corresponding physical ID 712, discussed further in association with FIG. 5 and FIG. 4. To broaden the example, consider from step 708 onward that the command at step 702 is a command causing a response at a selected outlet(s). At step 708, for each physical outlet found (step 704), the process described in step 714 to step 724 is performed one at a time. At step 714 the first (or next) physical outlet is selected. The command to the physical outlet may be any command that the corresponding physical out let is capable of responding to. For the example of adding outlets to the list, an example command may be to request the status of the outlet, last current reading, or others 718. At step 720 the result, if any, of the command 718 is stored. Results include a handshake signal, current reading, status signal, or nothing at all. That is, not all commands have a corresponding response signal. At step 722 a flag is set to indicate that the instant outlet has been successfully processed. In some embodiments a status byte is saved. At step 724 the list of step 708 is tested (for example, by examining all flags and/or status bytes) to determine if all selected outlets 704 have been processed. This may also be done by using a stack, PUSHing the address of selected outlets onto the stack, then POPing them until the stack is empty. Step 726 forms a message for transmission back to the requester, the response step being taken at step 728.

The details of control flow 700 vary, depending upon the design of the controller and the resources provided by each PDU and PDU outlet. For example, some embodiments do not include a handshake or return response. FIG. 7 and its description show a sequential, one at a time process in the interest of clarity. However, parallel processing may also be used. For example, the steps 714 through 724 are described for one virtual power outlet at a time, but of course the sequence shown may be performed for an arbitrary number of virtual power outlets at the same time, noting that there are no dependencies between the multiple virtual power outlets. All such variations are within the scope of the present invention.

What is claimed is:

1. A system for managing one or more power outlets selected from each of a one or more power distribution units, wherein each of the one or more power distribution units includes means to individually manage each selected power outlet comprising the power distribution unit and further includes an input terminal for receiving electronic signals, thereby forming a virtual power distribution unit, the system comprising:
a controller comprising:
an electronic data storage device for storing data corresponding to each of the power outlets, and
means to send signals to an output terminal, wherein each signal corresponds to a portion of the data, said portion corresponding to a certain power outlet; and
an electronic path for carrying the signal from the output terminal of the controller to the input terminal of each power distribution unit.

2. The system according to claim 1, wherein the storage device is semiconductor memory.

3. The system according to claim 1, wherein the storage device is a hard disc drive.

4. The system according to claim 1, wherein the storage device is a removable floppy disc.

5. The system according to claim 1, wherein the storage device is a compact disc.

6. The system according to claim 1, wherein the means for providing an output signal to the output terminal comprises:
a storage device for storing the data;
a storage device for storing program instructions; and
a microprocessor for executing the program instructions.

7. The system according to claim 6, wherein the device for storing the data is semiconductor memory.

8. The system according to claim 6, wherein the device for storing program instructions is semiconductor memory.

9. The system according to claim 1, wherein the electronic path comprises a local area network.

10. The system according to claim 1 further comprising an input terminal to the controller and an output terminal from at least one of the one or more power distribution units.

11. The system according to claim 10, wherein the electronic path includes a connection to the internet.

12. The system according to claim 10, wherein the electronic data path further includes a gateway.

13. The system according to claim 10, wherein the electronic data path further includes a server.

14. A method for managing one or more power outlets selected from each of a one or more power distribution units to form a virtual power distribution unit, the method comprising the steps of:
a. receiving a command;
b. creating a list of power outlets, the power outlets selected according to a meaning of the command, wherein each power outlet has a unique identification symbol, each identification symbol corresponding to a unique identification symbol of a virtual power outlet associated with a certain virtual power distribution unit;
c. performing an operation responsive to the command on a database record, wherein the database record corresponds to a certain power outlet from the list of power outlets; and
d. repeating the method from step “c.” for each database record corresponding to each power outlet on the list of power outlets until the command has been responded to for all power outlets on the list of power outlets.

15. The method according to claim 14, wherein the meaning of the command is to turn a power outlet ON.

16. The method according to claim 14, wherein the meaning of the command is to turn a power outlet OFF.

17. The method according to claim 14, wherein the meaning of the command is to request data from the power outlet.

18. The method according to claim 14, wherein the meaning of the command is to associate a selected power outlet with a selected virtual power outlet of a given virtual power distribution unit.

19. The method according to claim 14, wherein the meaning of the command is to disassociate a selected power outlet from a selected virtual power outlet of a given virtual power distribution unit.
